(19) United States
(12) Patent Application Publication
(10) Pub. No.: US 2024/0232692 A9
(43) Pub. Date: Jul. 11, 2024

(54) METHOD FOR TREE-BASED MACHINE LEARNING MODEL REDUCTION AND ELECTRONIC DEVICE USING THE SAME

(71) Applicant: Industrial Technology Research Institute, Hsinchu (TW)

(72) Inventors: Shih-Chang Chen, Hsinchu City (TW); Chao-Chun Yeh, Hsinchu County (TW)

(73) Assignee: Industrial Technology Research Institute, Hsinchu (TW)

(21) Appl. No.: 18/077,173

(22) Filed: Dec. 7, 2022

(30) Foreign Application Priority Data
Oct. 25, 2022 (TW) 111140345

(51) Int. Cl. G06N 20/00

(52) U.S. Cl. CPC G06N 20/00

(57) ABSTRACT

The disclosure provides a method for tree-based machine learning model reduction and an electronic device using the same. A boosting tree model including multiple subtrees is obtained. Subtree importance of each of the subtrees is determined according to feature importance information respectively corresponding to multiple model features of the boosting tree model. At least one continuous tree subset is extracted from the subtrees according to the subtree importance of each of the subtrees. The at least one continuous tree subset includes at least one of the subtrees. At least one reduced boosting tree model of the boosting tree model is obtained according to the at least one continuous tree subset.

### CROSS-REFERENCE TO RELATED APPLICATION

This application claims the priority benefit of Taiwan application serial no. 111140345, filed on Oct. 25, 2022. The entirety of the above-mentioned patent application is hereby incorporated by reference herein and made a part of this specification.

### TECHNICAL FIELD

The disclosure relates to a method for tree-based machine learning model reduction and an electronic device using the same.

### BACKGROUND

A decision tree is a supervised machine learning model with a tree-like structure. The decision tree is intuitive and efficient in execution and can be used to deal with classification or regression problems. Therefore, the application range of the decision tree is quite extensive. On the other hand, the boosting method in ensemble learning is a commonly used statistical learning method, which is a machine learning algorithm that may convert a weak classifier into a strong classifier. At present, the boosting method may be used to linearly combine multiple decision trees to establish a boosting tree model with more accurate prediction results. The boosting tree model has received considerable attention due to the excellent prediction accuracy thereof. In addition, tree-based machine learning models (such as the boosting tree model) are more suitable than neural network models to be deployed on hardware with limited computing resources, such as embedded devices in practical fields of industrial control. However, when the network traffic in the practical fields suddenly increases, the tree-based machine learning model will not be able to handle it, which increases the risk of malicious industrial control threats. Therefore, in order to speed up model inference, reduction processing may be performed on the tree-based machine learning model to reduce the risk of malicious industrial control threats. Taking the boosting tree model as an example, the reduction of the boosting tree model may be performed during the model training process or after the training is completed.

When the boosting tree model is required to be reduced during the model training process, pruning may be performed on the boosting tree model, such as limiting the height, width, or number of leaves of the tree structure. However, after the training of the boosting tree model is completed, if the practical application field of the boosting tree model has unexpected changes (such as sudden increase in the network traffic, replacement of field hardware, etc.), the pruning may not be performed. On the other hand, when the boosting tree model is required to be reduced after the model training is completed, quantization or slicing selection may be performed on the boosting tree model. However, although quantizing the nodes and leaves' values of the trained boosting tree model may reduce the size of boosting tree model, it will reduce the accuracy of the boosting tree model. In addition, although the slicing selection performed on the trained boosting tree model may reduce the size of boosting tree model, it is possible to obtain a tree subset with lower accuracy. Furthermore, it is time-consuming to evaluate all the tree subsets.

### SUMMARY

The disclosure provides a method for tree-based machine learning model reduction and an electronic device using the same, which may efficiently reduce the size of a trained boosting tree model and obtain a reduced boosting tree model with good inference accuracy.

The disclosure provides a method for tree-based machine learning model reduction including the following steps. A boosting tree model including multiple subtrees is obtained. Subtree importance of each of the subtrees is determined according to feature importance information respectively corresponding to multiple model features of the boosting tree model. At least one continuous tree subset is extracted from the subtrees according to the subtree importance of each of the subtrees. The at least one continuous tree subset includes at least one of the subtrees. At least one reduced boosting tree model of the boosting tree model is obtained according to the at least one continuous tree subset.

The disclosure provides an electronic device, including a storage device and a processor. The storage device records multiple instructions. A processor which is coupled to the storage device accesses and executes the instructions to perform the following steps. A boosting tree model including multiple subtrees is obtained. Subtree importance of each of the subtrees is determined according to feature importance information respectively corresponding to multiple model features of the boosting tree model. At least one continuous tree subset is extracted from the subtrees according to the subtree importance of each of the subtrees. The at least one continuous tree subset includes at least one of the subtrees. At least one reduced boosting tree model of the boosting tree model is obtained according to the at least one continuous tree subset.

Based on the above, in the embodiments of the disclosure, the subtree importance of each of the subtrees of the boosting tree model may be determined according to the feature importance information of each of the model features. Thus, the subtree importance of each of the subtrees may be used to obtain the at least one continuous tree subset from the continuous subtrees, and thereby obtain the at least one reduced boosting tree model of the boosting tree model.

### BRIEF DESCRIPTION OF THE DRAWINGS

FIG. 1 is a schematic view of an electronic device according to an embodiment of the disclosure.

FIG. 2 is a flowchart of a method for tree-based machine learning model reduction according to an embodiment of the disclosure.

FIG. 3 is a flowchart of a method for tree-based machine learning model reduction according to an embodiment of the disclosure.

### DETAILED DESCRIPTION OF DISCLOSED EMBODIMENTS

Some embodiments of the disclosure accompanied with the drawings will now be described in detail. For the reference numerals recited in description below, the same reference numerals shown in different drawings will be regarded as the same or similar elements. These embodiments are only a part of the disclosure, and do not disclose all the possible implementations of the disclosure. To be more precise, these embodiments are only examples of methods and devices in the appended claims of the disclosure.

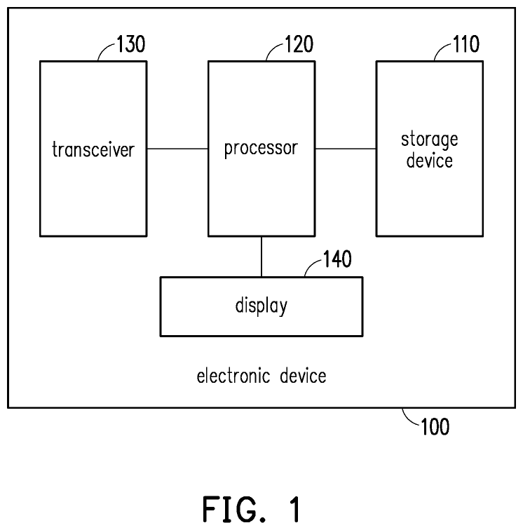

FIG. 1 is a schematic view of an electronic device according to an embodiment of the disclosure. Referring to FIG. 1, an electronic device 100 may include a storage device 110, a processor 120, a transceiver 130, and a display 140. The electronic device 100 is, for example, a computer apparatus, a server, or other computer devices with computing capability.

The storage device 110 is, for example, any type of fixed or removable random access memory (RAM), read-only memory (ROM), flash memory, hard disk drive (HDD), solid state drive (SSD), similar elements, or a combination of the above elements for storing multiple instructions, program codes, software modules, or various applications executed by the processor 120.

The processor 120 is, for example, a central processing unit (CPU), other programmable general-purpose or special-purpose micro control units (MCUs), a microprocessor, a digital signal processor (DSP), a programmable controller, an application specific integrated circuit (ASIC), a graphics processing unit (GPU), a complex programmable logic device (CPLD), a field programmable gate array (FPGA), other similar elements, or a combination of the above elements.

The transceiver 130 transmits and receives signals in a wireless or wired manner. The transceiver 130 may further perform operations such as low noise amplification, impedance matching, frequency mixing, upward or downward frequency conversion, filtering, amplification, or the like.

The display 140 may be various types of displays such as a liquid crystal display (LCD), a light emitting diode (LED) display, and an organic light emitting diode (OLED). The disclosure is not limited thereto.

The processor 120 may be coupled to the storage device 110, the transceiver 130, and the display 140, and accesses and executes the instructions, program codes, software modules, or various applications stored in the storage device 110, so as to implement a method for tree-based machine learning model reduction provided in the disclosure, and details thereof will be described in the following.

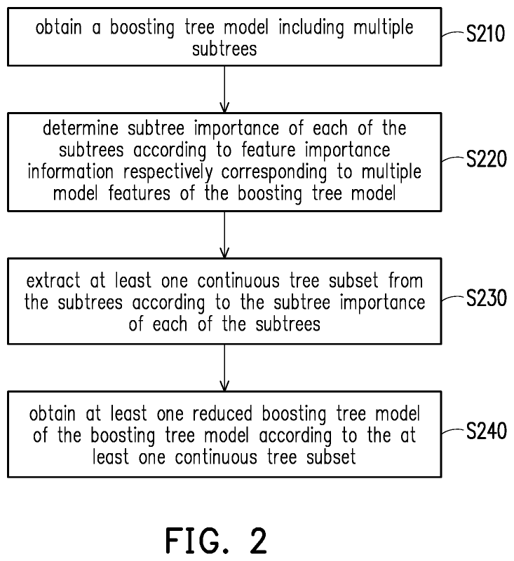

FIG. 2 is a flowchart of a method for tree-based machine learning model reduction according to an embodiment of the disclosure. Referring to FIG. 2, the method in this embodiment is applicable to the electronic device 100 in FIG. 1, and details of each of steps in FIG. 2 will be described below with the elements shown in FIG. 1.

In step S210, the processor 120 obtains a boosting tree model including multiple subtrees. Here, the boosting tree model obtained by the processor 120 has been trained based on a training dataset. In some embodiments, a user device may upload the trained boosting tree model to the electronic device 100 through a network or any data transmission interface. Correspondingly, the processor 120 may obtain the boosting tree model through the transceiver 130.

It should be noted that the trained boosting tree model obtained by the processor 120 includes the subtrees. The subtrees are decision trees and are sequentially concatenated into the boosting tree model. Based on a boosting learning principle of the boosting tree model, the subtrees are generated sequentially with a specific order relation. That is, each of the subtrees in the boosting tree model has its own ordinal number. In addition, the number of subtrees is not limited in the disclosure, and the number of classification categories of the subtrees is also not limited in the disclosure. The boosting tree model is, for example, a gradient boosting tree, an eXtreme gradient boosting tree (XGBoost tree), etc., but the disclosure is not limited thereto.

In step S220, the processor 120 determines subtree importance of each of the subtrees according to feature importance information respectively corresponding to multiple model features of the boosting tree model. Specifically, in a model training stage, a decision tree algorithm applied to the subtrees may determine the model features for building the subtrees according to the training dataset. The above decision tree algorithm is, for example, ID3, C4.5, CART, CHAID, etc., but the disclosure is not limited thereto. After the training of the boosting tree model is completed, the feature importance information of the model features is also generated correspondingly. The feature importance information of the model features may include feature importance, feature usage counts, etc. In some embodiments, the feature importance information is provided to the processor 120 together with the boosting tree model. Therefore, the processor 120 may determine the subtree importance of each of the subtrees according to the feature importance information of the model features. That is, the subtree importance of each of the subtrees is determined according to the feature importance information of the model features used by each of the subtrees.

In step S230, the processor 120 extracts at least one continuous tree subset from the subtrees according to the subtree importance of each of the subtrees. The continuous tree subset includes at least one of the subtrees. That is, the continuous tree subset is determined according to the subtree importance of each of the subtrees. In some embodiments, the processor 120 may perform slicing selection on the subtrees to generate the at least one continuous tree subset. In addition, in some embodiments, the processor 120 may determine the important subtrees and the unimportant subtrees in the subtrees according to the subtree importance of each of the subtrees. Afterwards, the processor 120 may extract the at least one continuous tree subset from the subtrees according to the important subtrees or the unimportant subtrees, and each of the continuous tree subsets may include one subtree or multiple continuous subtrees. For example, it is assumed that the original boosting tree model includes 10 subtrees, which are a subtree #1 to a subtree #10, and the continuous tree subset may include 5 subtrees, which are the subtree #2 to the subtree #6, respectively.

Next, in step S240, the processor 120 obtains at least one reduced boosting tree model of the boosting tree model according to the at least one continuous tree subset. In some embodiments, the processor 120 may retain a portion of the at least one continuous tree subset according to a model evaluation metric and/or a model file size of each of the continuous tree subsets, thereby obtaining the at least one reduced boosting tree model of the boosting tree model. The processor 120 may utilize the reduced boosting tree model to generate an inference result according to network transmission data. It should be noted that the processor 120 may use a test dataset to perform a model test on each of the continuous tree subsets extracted based on the subtree importance, so as to obtain the model evaluation metric of each of the continuous tree subsets. On this basis, in the embodiment of the disclosure, not only may reduction of the boosting tree model be completed efficiently, but the reduced boosting tree model also has good model performance. In addition, the reduced boosting tree model may be used by an embedded chip in an industrial control apparatus. In this way, when the processor 120 inputs to the reduced boosting tree model according to the network transmission data to generate the inference result, the processing speed may be effectively improved, and the processing time may be shortened, thereby avoiding failure of the industrial control apparatus caused by attacks in network traffic.

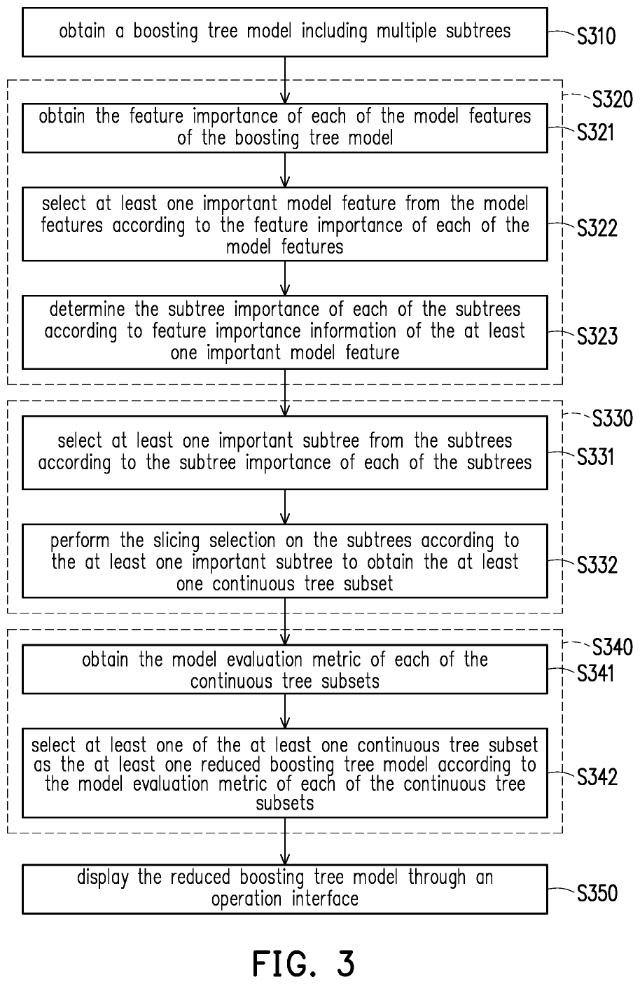

FIG. 3 is a flowchart of a method for tree-based machine learning model reduction according to an embodiment of the disclosure. Referring to FIG. 3, the method in this embodiment is applicable to the electronic device 100 in FIG. 1, and details of each of steps in FIG. 3 will be described below with the elements shown in FIG. 1.

In step S310, the processor 120 obtains the boosting tree model including the subtrees. In step S320, the processor 120 determines the subtree importance of each of the subtrees according to the feature importance information respectively corresponding to the model features of the boosting tree model. In some embodiments, step S320 may be implemented as step S321 to step S323.

In step S321, the processor 120 obtains the feature importance of each of the model features of the boosting tree model. In some embodiments, the feature importance of each of the model features may be determined according to a Gini index or an information gain, and the processor 120 may obtain the feature importance of each of the model features uploaded by the user device through the transceiver 130. For example, by using the XGBoost package of the programming language Python, the feature importance information of the model features of each of the subtrees in the boosting tree model may be generated, and the feature importance information of the model features includes the feature importance and the feature usage counts.

In step S322, the processor 120 selects at least one important model feature from the model features according to the feature importance of each of the model features. The disclosure does not limit the number of important model features, which may be determined by practical applications. The processor 120 may select the model features with higher feature importance as the important model features.

In some embodiments, the processor 120 may perform a statistical operation on the feature importance of each of the model features to obtain a feature importance statistic value. The statistical operation is, for example, calculating an average value, taking a median, taking a quartile, etc. Next, the processor 120 may select the at least one important model feature according to the feature importance statistic value. Feature importance of the important model feature is greater than the feature importance statistic value. For example, Table 1 is an example of the feature importance of the model features.

TABLE 1

| Model feature | Feature importance |
|---|---|
| Feature #0 | 0.00017103 |
| Feature #1 | 0.00046922 |
| Feature #2 | 0.0 |
| . . . | . . . |
| Feature #11 | 0.0000870 |
| Feature #12 | 0.20689587 |
| Feature #13 | 0.0 |
| Feature #14 | 0.0008967 |
| Feature #15 | 0.0004862 |
| . . . | . . . |
| Feature #21 | 0.39506018 |
| . . . | . . . |
| Feature #77 | 0.0 |
| Feature #78 | 0.0 |

According to Table 1, the processor 120 may calculate an average value A1 of the feature importance of 79 model features. The feature importance of both the feature #12 and the feature #21 is greater than the average value A1. Therefore, the processor 120 may select the feature #12 and the feature #21 as the important model features.

In other embodiments, the processor 120 may perform ranking according to the feature importance of each of the model features and select the top N model features as the important model features. For example, the processor 120 may select the top 5 model features in the ranking of the feature importance as the important model features.

In step S323, the processor 120 determines the subtree importance of each of the subtrees according to feature importance information of the at least one important model feature.

In some embodiments, the processor 120 may determine the subtree importance of each of the subtrees according to whether each of the subtrees uses the important model features and the feature importance of the important model features. If one certain subtree uses multiple important model features, the processor 120 may add up the feature importance of the important model features used by the subtree as the subtree importance.

In some implementations, the processor 120 may obtain the feature usage count of each of the model features used by each of the subtrees. Next, the processor 120 may determine the subtree importance of each of the subtrees according to the feature usage count of each of the subtrees using the at least one important model feature and the feature importance of the at least one important model feature. For example, for each of the subtrees, the processor 120 may generate the subtree importance according to a product of the feature importance of the important model features and the feature usage counts. For example, Table 2 is an example of the feature usage counts of the model features of the subtree #1.

TABLE 2

| Model feature | Feature importance |
|---|---|
| Feature #21 | 1 |
| Feature #23 | 2 |
| Feature #1 | 2 |
| . . . | . . . |
| Feature #25 | 2 |
| Feature #9 | 1 |
| Feature #12 | 2 |
| Feature #3 | 4 |
| Feature #62 | 1 |

Referring to Table 1 and Table 2, it is assumed that the important model features are the feature #12 and the feature #21. The processor 120 may multiply the feature importance of “0.20689587” of the feature #12 by the feature usage count of “2” to obtain a first value of “0.20689587*2”. The processor 120 may multiply the feature importance of “0.39506018” of the feature #21 by the feature usage count of “1” to obtain a second value of “0.39506018*1”. Next, the processor 120 may accumulate the first value of “0.20689587*2” and the second value of “0.39506018*1” to generate the subtree importance of “0.80885192” of the subtree #1.

In step S330, the processor 120 extracts the at least one continuous tree subset from the subtrees according to the subtree importance of each of the subtrees. In some embodiments, step S330 may be implemented as step S331 to step S332.

In step S331, the processor 120 selects at least one important subtree from the subtrees according to the subtree importance of each of the subtrees. That is, the processor 120 may select at least one of the subtrees as the at least one important subtree according to the subtree importance of each of the subtrees.

In some embodiments, the processor 120 may perform statistical operation on the subtree importance of each of the subtrees to obtain a subtree importance statistic value. The statistical operation is, for example, calculating an average value, taking a median, taking a quartile, etc. The processor 120 may select the at least one important subtree according to the subtree importance statistic value, and subtree importance of the important subtree is greater than the subtree importance statistic value. For example, Table 3 is an example of the subtree importance of 10 subtrees.

TABLE 3

| Subtree | Subtree importance |
|---|---|
| Subtree #1 | 0.80885192 |
| Subtree #2 | 0.80885192 |
| Subtree #3 | 0.60195605 |
| Subtree #4 | 0.60195605 |
| Subtree #5 | 0.60195605 |
| Subtree #6 | 0.80885192 |
| Subtree #7 | 0.60195605 |
| Subtree #8 | 0.60195605 |
| Subtree #9 | 1.01574780 |
| Subtree #10 | 0.60195605 |

Referring to Table 3, the processor 120 may perform an average operation on the subtree importance of the subtree #1 to the subtree #10 to obtain an average value of “0.7054039”. Next, since the subtree importance of the subtree #1, the subtree #2, the subtree #6, and the subtree #9 are all greater than the average value of “0.7054039”, the processor 120 may select the subtree #1, the subtree #2, the subtree #6, and the subtree #9 as the important subtrees.

In some embodiments, the subtrees of the boosting tree model include multiple first subtrees, and the subtree importance of each of the first subtrees is less than the subtree importance statistic value. When the first subtrees have the same subtree importance as one another, and the number of subtrees of the first subtrees is greater than or equal to a threshold value, the processor 120 may select one of the first subtrees as the important subtree. Assuming that the total number of subtrees is M, the threshold value may be, for example, M/2 or M/3, but the disclosure is not limited thereto. Taking Table 3 as an example, the subtree importance of the subtree #3, the subtree #4, the subtree #5, the subtree #7, the subtree #8, and the subtree #10 are all less than the average value of “0.7054039”. The subtree #3, the subtree #4, the subtree #5, the subtree #7, the subtree #8, and the subtree #10 have the same subtree importance as one another (which are all “0.60195605”), and the number of subtrees that contains the subtree #3, the subtree #4, the subtree #5, the subtree #7, the subtree #8, and the subtree #10 is greater than a threshold value of “5”. The processor 120 may select one of the subtree #3, the subtree #4, the subtree #5, the subtree #7, the subtree #8, or the subtree #10 as the important subtree. For example, the processor 120 may select the subtree #10 as the important subtree.

In addition, in some embodiments, since all the subtrees are generated based on an initial subtree (the subtree with an ordinal number of 1), the processor 120 may directly select the initial subtree of the subtrees as the important subtree. That is, even if subtree importance of the initial subtree is less than the subtree importance statistic value, the processor 120 still selects the initial subtree as the important subtree.

In step S332, the processor 120 performs the slicing selection on the subtrees according to the at least one important subtree to obtain the at least one continuous tree subset.

In some embodiments, the processor 120 may perform the slicing selection on the subtrees by using the at least one important subtree as a beginning subtree or a trailing subtree. Here, the beginning subtree or the trailing subtree of the continuous tree subset is the important subtree. Taking Table 3 as an example to continue the description, it is assumed that the processor 120 selects the subtree #1, the subtree #2, the subtree #6, the subtree #9, and the subtree #10 as the important subtrees. By using the subtree #1, the subtree #2, the subtree #6, the subtree #9, and the subtree #10 as the beginning subtrees or the trailing subtrees of the continuous tree subset, the processor 120 may extract multiple continuous tree subsets.

For example, by using the subtree #1 as the beginning subtree of the continuous tree subset, the processor 120 may obtain 10 continuous tree subsets, which are {the subtree #1}, {the subtree #1 to the subtree #2}, {the subtree #1 to the subtree #3}, {the subtree #1 to the subtree #4}, {the subtree #1 to the subtree #5}, {the subtree #1 to the subtree #6}, {the subtree #1 to the subtree #7}, {the subtree #1 to the subtree #8}, {the subtree #1 to the subtree #9}, and {the subtree #1 to the subtree #10} respectively. It should be noted that because the continuous tree subset of {the subtree #1 to the subtree #10} is an original model, the processor 120 will not select the continuous tree subset of {the subtree #1 to the subtree #10} for subsequent model evaluations, and will not use the continuous tree subset of {the subtree #1 to the subtree #10} as the reduced boosting tree model. In addition, by using the subtree #2 as the beginning subtree of the continuous tree subset, the processor 120 may obtain 9 continuous tree subsets, which are {the subtree #2}, {the subtree #2 to the subtree #3}, {the subtree #2 to the subtree #4}, {the subtree #2 to the subtree #5}, {the subtree #2 to the subtree #6}, {the subtree #2 to the subtree #7}, {the subtree #2 to the subtree #8}, {the subtree #2 to the subtree #9}, and {the subtree #2 to the subtree #10} respectively. The rest may be derived in a similar fashion.

For example, by using the subtree #6 as the trailing subtree of the continuous tree subset, the processor 120 may obtain 6 continuous tree subsets, which are {the subtree #1 to the subtree #6}, {the subtree #2 to the subtree #6}, {the subtree #3 to the subtree #6}, {the subtree #4 to the subtree #6}, {the subtree #5 to the subtree #6}, and {the subtree #6} respectively. The rest may be derived in a similar fashion. The processor 120 may obtain the continuous tree subsets by using the subtree #1, the subtree #2, the subtree #6, the subtree #9, and the subtree #10 as the trailing subtrees of the continuous tree subset.

In some embodiments, the processor 120 may obtain at least one unimportant subtree by excluding the at least one important subtree from the subtrees. The processor 120 may perform the slicing selection on the subtrees by avoiding using the at least one unimportant subtree as the beginning subtree or the trailing subtree. Here, the beginning subtree or the trailing subtree of the continuous tree subset is not the important subtree. Taking Table 3 as an example to continue the description, it is assumed that the processor 120 selects the subtree #1, the subtree #2, the subtree #6, the subtree #9, and the subtree #10 as the important subtrees. The processor 120 may obtain the at least one unimportant subtree by excluding the above important subtrees from the subtrees. That is, the processor 120 may determine that the subtree #3, the subtree #4, the subtree #5, the subtree #7, and the subtree #8 are the unimportant subtrees.

Thus, by avoiding using the subtree #3, the subtree #4, the subtree #5, the subtree #7, and the subtree #8 as the beginning subtrees or the trailing subtrees of the continuous tree subset, the processor 120 may extract the continuous tree subsets. In some embodiments, the processor 120 may perform the slicing selection on the subtrees by excluding unimportant sets with the subtree #3, the subtree #4, the subtree #5, the subtree #7, and the subtree #8 as the beginning subtrees. For example, the processor 120 may perform the slicing selection on the subtrees by excluding unimportant sets of {the subtree #3}, {the subtree #3 to the subtree #4}, {the subtree #3 to the subtree #5}, {the subtree #3 to the subtree #6}, {the subtree #3 to the subtree #7}, {the subtree #3 to the subtree #8}, {the subtree #3 to the subtree #9}, and {the subtree #3 to the subtree #10} with the subtree #3 as the beginning subtree. The rest may be derived in a similar fashion.

Next, in step S340, the processor 120 obtains the at least one reduced boosting tree model of the boosting tree model according to the at least one continuous tree subset. In some embodiments, step S340 may be implemented as step S341 to step S342.

In step S341, the processor 120 obtains the model evaluation metric of each of the continuous tree subsets. The processor 120 may use the test dataset to evaluate model's performance on the continuous tree subset obtained based on the important subtree. When the processor 120 performs model evaluation on one certain continuous tree subset, the processor 120 may input multiple input data from the test dataset into the continuous tree subset to obtain multiple model prediction results respectively. Afterwards, the processor 120 may obtain the model performance of the continuous tree subset according to the model prediction results and corresponding real solutions.

In some embodiments, when boosting tree model is used to deal with classification problems, the model evaluation metric of each of the continuous tree subsets may be F1-score, accuracy, recall, or precision. In some embodiments, when the boosting tree model is used for regression problems, the model evaluation metric of each of the continuous tree subsets may be root mean squared error (RMSE), mean absolute error (MAE), or mean absolute percentage error (MAPE).

In step S342, the processor 120 selects at least one of the at least one continuous tree subset as the at least one reduced boosting tree model according to the model evaluation metric of each of the continuous tree subsets. Specifically, after the model's performance is evaluated on the continuous tree subsets respectively, the processor 120 may select one or more of the continuous tree subsets as the reduced boosting tree model.

In some embodiments, processor 120 may compare the model evaluation metric of each of the continuous tree subsets to a model evaluation metric of the original boosting tree model to select one or more first continuous tree subsets from the continuous tree subsets as the reduced boosting tree models. Wherein, model evaluation metrics of the reduced boosting tree models are better than the model evaluation metric of the original boosting tree model.

In some embodiments, the processor 120 may further select one or more first continuous tree subsets from the continuous tree subsets as the reduced boosting tree models according to a file size of each of the continuous tree subsets. For example, file sizes of the reduced boosting tree models are less than a threshold value.

In some embodiments, the processor 120 may directly select all the continuous tree subsets as the at least one reduced boosting tree model.

Finally, in step S350, the processor 120 controls the display 140 to display the reduced boosting tree model through an operation interface. In some embodiments, the operation interface further displays the file size of each of the reduced boosting tree model and the corresponding continuous tree subset for a user to view.

Based on the above, in the method according to the embodiment of the disclosure, the important model features may be selected from the model features used by the subtrees of the trained boosting tree model, and the subtrees importance of each of the subtrees may be calculated according to the important model features. Thus, the continuous tree subset including at least one subtree may be generated according to the subtree importance of each of the subtrees. By evaluating the model's performance of the continuous tree subsets, the reduced boosting tree model with good accuracy may be obtained. On this basis, in the embodiments of the disclosure, not only may the model reduction be efficiently performed on the already trained boosting tree model, but also the reduced boosting tree model with good accuracy may be obtained. In addition, the reduced boosting tree model determined by the method in the disclosure is suitable for various situational requirements; it may greatly improve the inference speed and may cope with unexpected changes in the actual field. As a result, the risk of malicious industrial control threats may be reduced.

Although the disclosure has been described with reference to the above embodiments, they are not intended to limit the disclosure. It will be apparent to one of ordinary skill in the art that modifications to the described embodiments may be made without departing from the spirit and the scope of the disclosure. Accordingly, the scope of the disclosure will be defined by the attached claims and their equivalents and not by the above detailed descriptions.

What is claimed is:

1. A method for tree-based machine learning model reduction, suitable for an electronic device comprising a processor, comprising:
obtaining a boosting tree model comprising a plurality of subtrees;
determining subtree importance of each of the subtrees according to feature importance information respectively corresponding to a plurality of model features of the boosting tree model;
extracting at least one continuous tree subset from the subtrees according to the subtree importance of each of the subtrees, wherein the at least one continuous tree subset comprises at least one of the subtrees; and
obtaining at least one reduced boosting tree model of the boosting tree model according to the at least one continuous tree subset.

2. The method for tree-based machine learning model reduction according to claim 1, wherein determining the subtree importance of each of the subtrees according to the feature importance information respectively corresponding to the model features of the boosting tree model comprises:
obtaining feature importance of each of the model features of the boosting tree model;
selecting at least one important model feature from the model features according to the feature importance of each of the model features; and
determining the subtree importance of each of the subtrees according to the feature importance information of the at least one important model feature.

3. The method for tree-based machine learning model reduction according to claim 2, wherein determining the subtree importance of each of the subtrees according to the feature importance information of the at least one important model feature comprises:
obtaining a feature usage count of each of the model features used by each of the subtrees; and
determining the subtree importance of each of the subtrees according to the feature usage count of each of the subtrees using the at least one important model feature and the feature importance of the at least one important model feature.

4. The method for tree-based machine learning model reduction according to claim 2, wherein selecting the at least one important model feature from the model features according to the feature importance of each of the model features comprises:
performing a statistical operation on the feature importance of each of the model features to obtain a feature importance statistic value; and
selecting the at least one important model feature according to the feature importance statistic value, wherein the feature importance of the at least one important model feature is greater than the feature importance statistic value.

5. The method for tree-based machine learning model reduction according to claim 1, wherein extracting the at least one continuous tree subset from the subtrees according to the subtree importance of each of the subtrees comprises:
selecting at least one important subtree from the subtrees according to the subtree importance of each of the subtrees; and
obtaining the at least one continuous tree subset by performing slicing selection on the subtrees according to the at least one important subtree.

6. The method for tree-based machine learning model reduction according to claim 5, wherein selecting the at least one important subtree from the subtrees according to the subtree importance of each of the subtrees comprises:
performing a statistical operation on the subtree importance of each of the subtrees to obtain a subtree importance statistic value; and
selecting the at least one important subtree according to the subtree importance statistic value, wherein the subtree importance of the at least one important subtree is greater than the subtree importance statistic value.

7. The method for tree-based machine learning model reduction according to claim 6, wherein the subtrees comprise a plurality of first subtrees, the subtree importance of each of the first subtrees is less than the subtree importance statistic value, and selecting the at least one important subtree from the subtrees according to the subtree importance of each of the subtrees comprises:
when the first subtrees have the same subtrees importance as one another, and a number of subtrees of the first subtrees is greater than or equal to a threshold value, selecting one of the first subtrees as the at least one important subtree.

8. The method for tree-based machine learning model reduction according to claim 5, wherein selecting the at least one important subtree from the subtrees according to the subtree importance of each of the subtrees comprises:
selecting an initial subtree of the subtrees as the at least one important subtree.

9. The method for tree-based machine learning model reduction according to claim 5, wherein obtaining the at least one continuous tree subset by performing the slicing selection on the subtrees according to the at least one important subtree comprises:
performing the slicing selection on the subtrees by using the at least one important subtree as a beginning subtree or a trailing subtree, wherein the beginning subtree or the trailing subtree of the at least one continuous tree subset is the at least one important subtree.

10. The method for tree-based machine learning model reduction according to claim 5, wherein obtaining the at least one continuous tree subset by performing the slicing selection on the subtrees according to the at least one important subtree comprises:
obtaining at least one unimportant subtree by excluding the at least one important subtree from the subtrees; and
performing the slicing selection on the subtrees by avoiding using the at least one unimportant subtree as a beginning subtree or a trailing subtree, wherein the beginning subtree or the trailing subtree of the at least one continuous tree subset is not the at least one unimportant subtree.

11. The method for tree-based machine learning model reduction according to claim 1, wherein obtaining the at least one reduced boosting tree model of the boosting tree model according to the at least one continuous tree subset comprises:
obtaining a model evaluation metric of each of the at least one continuous tree subset; and
selecting at least one of the at least one continuous tree subset as the at least one reduced boosting tree model according to the model evaluation metric of each of the at least one continuous tree subset.

12. The method for tree-based machine learning model reduction according to claim 1, further comprising:
displaying the reduced boosting tree model through an operation interface.

13. An electronic device, comprising:
a storage device storing a plurality of instructions; and
a processor coupled to the storage device, and accessing and executing the instructions to:
obtain a boosting tree model comprising a plurality of subtrees;
determine subtree importance of each of the subtrees according to feature importance information respectively corresponding to a plurality of model features of the boosting tree model;
extract at least one continuous tree subset from the subtrees according to the subtree importance of each of the subtrees, wherein the at least one continuous tree subset comprises at least one of the subtrees; and
obtain at least one reduced boosting tree model of the boosting tree model according to the at least one continuous tree subset.

14. The electronic device according to claim 13, wherein the processor is further configured to:
obtain feature importance of each of the model features of the boosting tree model;
select at least one important model feature from the model features according to the feature importance of each of the model features; and
determine the subtree importance of each of the subtrees according to the feature importance information of the at least one important model feature.

15. The electronic device according to claim 14, wherein the processor is configured to:
obtain a feature usage count of each of the model features used by each of the subtrees; and
determine the subtree importance of each of the subtrees according to the feature usage count of each of the subtrees using the at least one important model feature and the feature importance of the at least one important model feature.

16. The electronic device according to claim 14, wherein the processor is configured to:
perform a statistical operation on the feature importance of each of the model features to obtain a feature importance statistic value; and
select the at least one important model feature according to the feature importance statistic value, wherein the feature importance of the at least one important model feature is greater than the feature importance statistic value.

17. The electronic device according to claim 13, wherein the processor is configured to:
select at least one important subtree from the subtrees according to the subtree importance of each of the subtrees; and
obtain the at least one continuous tree subset by performing slicing selection on the subtrees according to the at least one important subtree.

18. The electronic device according to claim 17, wherein the processor is configured to:
perform a statistical operation on the subtree importance of each of the subtrees to obtain a subtree importance statistic value; and
select the at least one important subtree according to the subtree importance statistic value, wherein the subtree importance of the at least one important subtree is greater than the subtree importance statistic value.

19. The electronic device according to claim 18, wherein the subtrees comprise a plurality of first subtrees, the subtree importance of each of the first subtrees is less than the subtree importance statistic value, and the processor is configured to:
when the first subtrees have the same subtrees importance as one another, and a number of subtrees of the first subtrees is greater than or equal to a threshold value, select one of the first subtrees as the at least one important subtree.

20. The electronic device according to claim 17, wherein the processor is configured to:
select an initial subtree of the subtrees as the at least one important subtree.

21. The electronic device according to claim 17, wherein the processor is configured to:
perform the slicing selection on the subtrees by using the at least one important subtree as a beginning subtree or a trailing subtree, wherein the beginning subtree or the trailing subtree of the at least one continuous tree subset is the at least one important subtree.

22. The electronic device according to claim 17, wherein the processor is configured to:
obtain at least one unimportant subtree by excluding the at least one important subtree from the subtrees; and
perform the slicing selection on the subtrees by avoiding using the at least one unimportant subtree as a beginning subtree or a trailing subtree, wherein the beginning subtree or the trailing subtree of the at least one continuous tree subset is not the at least one unimportant subtree.

23. The electronic device according to claim 13, wherein the processor is configured to:
obtain a model evaluation metric of each of the at least one continuous tree subset; and
select at least one of the at least one continuous tree subset as the at least one reduced boosting tree model according to the model evaluation metric of each of the at least one continuous tree subset.

24. The electronic device according to claim 13, wherein the processor is configured to:
display the reduced boosting tree model through an operation interface.
